(19) United States
(12) Patent Application Publication
(10) Pub. No.: US 2006/0054107 A1
(43) Pub. Date: Mar. 16, 2006

(54) Leash-attachable pouch for carrying dog waste, with plastic-stiffened fabric walls

(76) Inventor: Sandra L. Baker, Kirkwood, MO (US)

Correspondence Address: PATRICK D. KELLY, 11939 MANCHESTER #403, ST. LOUIS, MO, 63131, US

(21) Appl. No.: 10/940,402

(22) Filed: Sep. 14, 2004

(51) Int. Cl. A01K 27/00

(52) U.S. Cl. 119/795

(57) ABSTRACT

A waste-carrying pouch is disclosed, for use by pet owners to carry waste (feces) to a trash can or waste basket. The pouch hangs from a leash, near the handle, and can be reversibly opened and closed. An improved design uses a combination of: (i) two attachment points, positioned at the two ends of the pouch, to minimize swinging motion by a pouch loaded with waste, and (ii) walls made of a semi-stiff plastic-impregnated fabric, such as “420D” nylon with a polyvinyl chloride coating, to providea suitable degree of “stiffening” to make opening and closing the pouch easier and more reliable even when a leash is being jerked and tugged. Pouch-and-leash combinations are also with either standard or retractable leashes, having rings or other coupling devices on the leash, and pouch assortments are disclosed with a range of sizes.

### BACKGROUND OF THE INVENTION

This invention is in the field of devices for pet care, and more relates to a device that can make it more convenient and less unpleasant for a dog owner to clean up and dispose of dog waste (i.e., feces, excrement, poop, etc.), while walking a dog.

Numerous devices have been developed to make it easier and more convenient for dog owners to pick up waste from their dogs during walks. One such category of devices that should be recognized, but which is not relevant to this invention, are referred to herein as “pickup supply” devices, to distinguish them from “waste-carrying” devices, which are the subject of this invention. “Pickup supply” devices include, for example, small pouches designed to carry a readily-available supply of clean plastic bags (commonly called “baggies”) that can be used to pick up and carry dog waste. Such devices are described in various patents, including U.S. Pat. No. 5,363,809 (Roe 1994), U.S. Pat. No. 5,441,017 (Lindsay 1995), U.S. Pat. No. 5,890,637 (Furneaux 1999), U.S. Pat. No. 6,019,067 (Carey 2000), and U.S. Pat. No. 6,073,590 (Polding 2000). These types of pouches, designed to carry clean supplies rather than actual dog feces, are different and distinct from the types of waste-carrying devices disclosed herein.

As used herein, any reference to a waste-carrying pouch or device (or simply a carrying pouch, for convenience) refers to and is limited to a device that allows a dog owner to cleanly and conveniently carry dog waste that has already been picked up and placed inside an inexpensive and disposable plastic bag. Such waste carrying devices allow dog feces (inside a “baggie”) to be carried conveniently to a trash can, waste basket, or other suitable receptacle, for disposal.

If waste-carrying devices were designed properly, they would be as important, and as appreciated, as pickup devices. Pickup devices are used by all dog owners (at least, by all dog owners who are sufficiently respectful to clean up after their dogs), because they allow dog owners to avoid getting foul-smelling and unsanitary feces on their hands. However, the act of picking up dog waste takes only a few seconds. By contrast, the act of carrying around a pile of dog waste, after it has been picked up, takes much longer, and can intrude upon and interfere with other activities, such as conversations with neighbors or other dog owners, enjoying a walk outdoors, etc.

Despite their potential advantages, none of the waste-carrying devices that have been created to date have ever enjoyed any significiant commercial success or widespread use, and are not sold by any known pet store chains. A recent survey, by the Applicant herein, of stores that belong to a major national chain that specializes in pet supplies, and of discount stores that carry extensive assortments of pet supplies, indicated that none of those stores stocked or sold any waste-carrying pouchs, of any type, for mounting either on standard leashes or retractable leashes.

That absence of commercial success or widespread use apparently does not come from a lack of effort, because a number of patents have indeed been issued on waste-carrying devices that are designed to be attached to dog leashes. Such patents include U.S. Pat. No. 5,718,192 (Sebastian 1998), U.S. Pat. No. 6,085,695 (Miller et al 2000), U.S. Pat. No. 6,237,533 (Rodriguez 2001), U.S. Pat. No. 6,314,917 (Ryan 2001), and U.S. Pat. No. 6,418,881 (Starratt 2002). Additional types of waste-carrying pouches (apparently unpatented) also can be located, on small-scale websites on the Internet, if a determined effort is made to locate such devices (for example, a search for the combined words “dog, waste, pouch” will return thousands of “hits”, but most of the ones that advertise and sell products are for pouches designed for carrying keys, baggies, or other clean supplies, rather than pouches for carrying waste). If a person continues to search and knows exactly what he or she is looking for, pouches for carrying waste can be located at various websites, such as www.caninecarry-all.com, www.tugnomore.com/features.asp, and www.leerburg.com/758.htm.

In her efforts to develop a simple and low-cost waste-carrying pouch with the greatest possible convenience and utility, the Applicant herein has tested a fairly extensive series of candidate designs. During those tests, she recognized that even relatively minor factors and considerations, if not addressed and handled properly, can lead a dog owner to conclude that such devices are not worth the time and trouble to use, if that dog owner is already accustomed to using some other method for carrying the waste, after it has been picked up, during a dog-walking session.

For example, pouches that use walls made of conventional fabric are relatively flimsy, and tend to be difficult to close, after a small plastic bag (“baggie”) that is filled with waste has been loaded into the pouch. This normally would not appear to be a major impediment; however, many dogs begin carrying out accelerated levels of motion and activity, after they have “unloaded” and have become comfortable, and eager for a chance to run and explore, after being cooped up for most of the day inside a house or apartment. Therefore, attempting to close a flimsy-but-loaded open pouch that requires both hands to close, while at the same time trying to handle a leash that has an active and eager dog pulling and tugging at the other end, can be annoying and vexatious to a degree that can be startling and accident-prone, to someone who has never actually done it.

Furthermore, waste-carrying pouches such as the ones advertised on at the www.caninecarry-all.com and www.leerburg.com websites (as well as the design shown in U.S. Pat. No. 6,237,533, Rodriguez 2001) have only a single clip or VELCRO strap, for affixing those pouches to a leash. However, actual testing of such pouches, by the Applicant herein, made it clear that if a pouch dangles from a leash via a single attachment point, the amount of swinging, back-and-forth, “pendulous” motion by a loaded pouch can become annoying and distracting, for both the dog and the owner. Therefore, the pouches disclosed herein all have two attachment points, at opposing ends of the pouch.

In summary, even though numerous different dog owners have already thought of them, and have taken steps to patent and/or commercialize them, waste-carrying pouches have never caught on with dog owners, and are not used by the vast majority of dog owners who walk their dogs, apparently because they have not yet been optimized, in ways that will make them truly convenient, useful, and non-distracting, as well as affordable and available to the general public.

Therefore, one object of this invention is to disclose an improved design for a simple, lightweight, and inexpensive type of waste-carrying pouch that can be quickly and easily connected to any type of dog leash (either standard or retractable), to make it easy for dog owners to carry dog waste in a convenient, comfortable, inoffensive manner until they reach a trash can, waste basket, or other proper receptacle for dog waste.

Another object of this invention is to disclose an improved design for a simple, lightweight, and inexpensive type of waste-carrying pouch that has a combination of: (i) two attachment points, positioned at the two ends of the pouch, to minimize any “pendulous” swinging motion by a pouch that is loaded with waste, and (ii) walls made of a plastic-impregnated fabric that provides a suitable degree of “stiffening” that will make opening and closing the pouch easier, more convenient, and more safe and reliable, even when the leash is being actively jerked and tugged by a dog.

Another object of this invention is to disclose improved designs for simple, lightweight, and inexpensive dog leashes (either standard or retractable) having one or more components that make it simple and convenient to attach and carry a pouch for carrying dog waste.

These and other objects of the invention will become more clear through the following summary, description, and drawings.

### SUMMARY OF THE INVENTION

A convenient, lightweight, and inexpensive waste-carrying pouch is disclosed, for use by pet owners (especially dog owners) to carry waste (feces) to a trash can or waste basket, after the waste has been picked up by the pet owner. The pouch hangs from a on a leash, near the handle, and can be reversibly opened and closed, by means such as a zipper, hook-and-loop straps, etc. An improved design uses a combination of: (i) two attachment points, positioned at the two ends of the pouch, to minimize any “pendulous” swinging motion by a pouch loaded with waste, and (ii) walls made of a plastic-impregnated fabric (such as “420D” nylon with a polyvinyl chloride coating) that provides several davantages compared to prior efforts (including a suitable degree of “stiffening” to make opening and closing the pouch easier, more convenient, and more reliable when the leash is being actively jerked and tugged by a dog). Pouch-and-leash combinations are also disclosed, with either standard or retractable leashes, having rings or other coupling devices mounted on the leash. Pouch assortments also are disclosed, having a range of sizes that can be selected by dog owners, to accommodate small, medium, or large dogs.

### BRIEF DESCRIPTION OF THE DRAWINGS

FIG. 1 depicts a waste-carrying pouch, with two “hook and loop” (VELCRO™) attachment straps positioned near the two upper corners of the pouch, affixed to a standard (non-retractable) dog leash, using the hand-loop of the leash to prevent the pouch from sliding along the length of the leash.

FIG. 2 depicts a waste-carrying pouch affixed to a conventional non-modified retractable leash.

FIG. 3 depicts a standard dog leash that has been modified by affixing a clip-attachment ring into the leash near the handle, using two spaced stitching zones, and also comprising a plastic hand-grip for greater hand comfort when walking a dog that can pull hard against a leash.

FIG. 4 depicts a retractable dog leash that has been modified by adding a pouch-attachment clip to it.

### DETAILED DESCRIPTION

As summarized above, a simple, convenient, and inexpensive waste-carrying pouch is disclosed, for carrying dog waste to a trash can or waste basket, after the waste has been picked by a dog owner.

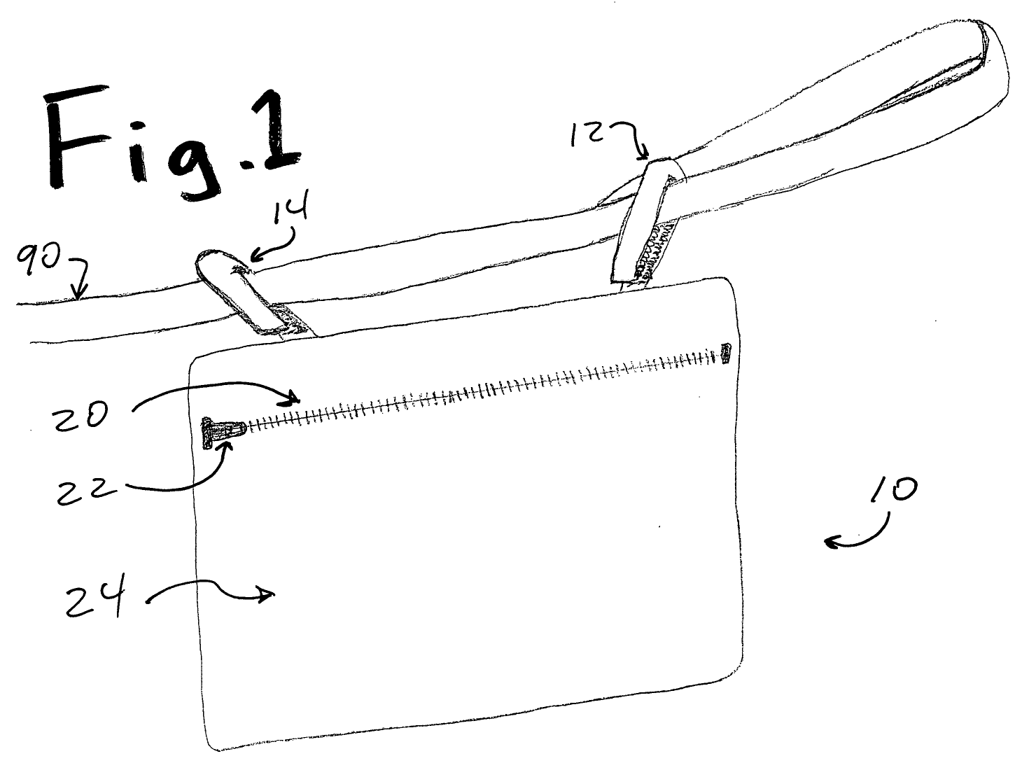

FIG. 1 depicts a waste-carrying pouch 10, affixed to and suspended beneath a standard (non-retractable) dog leash 90. Pouch 10 comprises two attachment components, illustrated in FIG. 1 as “hook and loop” straps 12 and 14 (commonly known by the trademark VELCRO™). Alternately, these attachment devices can comprise plastic or metal clips, or any other suitable affixing means. Any such straps, clips, or other such affixing means are also referred to herein as “leash-coupling means”, since their purpose is to allow the pouch to be affixed, in an easily-detachable manner, to a dog leash. In FIG. 1, a device for reversible opening and secure closure is indicated by zipper 20 with pull-tab 22, and callout number 24 indicates a side wall of pouch 10, made of a fabric such as 420D denier nylon that has been coated or impregnated with a waterproof plastic or other suitable material, such as polyvinyl chloride (PVC).

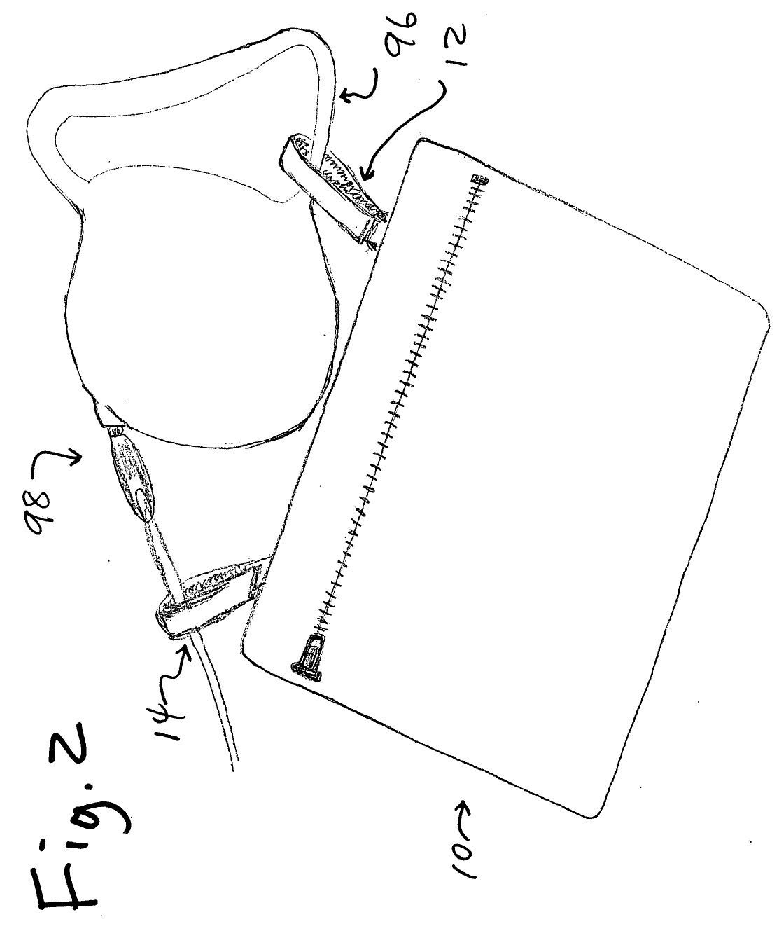

FIG. 2 illustrates how the same type of waste-carrying pouch 10 can be affixed to the molded plastic handle 96 of a conventional and non-modified retractable leash 98.

If pouch 10 has relatively square or rectangular dimensions, straps 12 and 14 preferably should be positioned moderately close to the two upper corners of pouch 10, near the ends of the pouch. The use of two spaced attachment points can minimize the amount of “pendulous” swinging motion by a pouch that is carrying waste. Scu pendulous motion can be distracting and uncomfortable, to both a dog and a dog owner.

To minimize unwanted pendulous motion while a full pouch dangles from a leash, the pouch should have a size that is large enough to carry a “large load” from the dog that is being walked, but it should not be substantially larger than that. This goal in turn suggests that different sizes should be made available for small, medium, or large dogs, so any pet owner can select and use a size that is appropriate for his or her dog(s). Suitable size ranges are discussed below.

To make assembly easier, during the manufacturing operation, pouch 10 can have a rectangular or square shape, closed on three sides and with an opening at or near one side edge. The opening needs to be conveniently opened when desired, and subsequently secured in the closed position. This can be accomplished by any suitable means, such as a zipper 20 with pull-tab 22, as shown. Alternate securing means can be provided, such as snaps, string loops with buttons, the type of hook-and-loop material commonly known as VELCRO™ (although hook-and-loop fasteners generally are not preferred, since they can be more difficult to clean than a zipper, if they become soiled by feces), or any other suitable means. The closure does not need to be airtight or watertight, so long as it can adequately hold a discardable plastic bag (“baggie”) that contains dog waste.

If the pouch has a rectangular or square shape, as shown in FIG. 1, it can be made by steps that will be readily apparent to anyone who knows how to sew.

Testing has indicated that waste-carrying pouches are easier (and safer, and more reliable) to use, if and when a dog is tugging and jerking on the leash, if the walls of the pouch are made of a suitable and somewhat stiffened material. A preferred material for such use comprises a nylon fabric having a suitable “denier” rating (such as about 420D, although other denier ratings, preferably ranging from about 150 to about 1000 can be used, if desired), which has been coated or impregnated with a suitable water-impermeable plastic material, such as polyvinyl chloride (abbreviated as PVC).

Alternately, other suitable materials can be used, such as a clear waterproof plastic having a suitable stiffness; this can ensure that a pet owner can easily see the contents of the pouch, and will not forget to empty the waste from the pouch after arriving back home (even if distracted by, for example, a ringing telephone). Alternately, some owners (especially in cold climates) may prefer a pouch made of an opaque waterproof plastic, which can be easily and quickly cleaned out whenever necessary (such as just before walking a dog), and then dried immediately, by swabbing it out with a paper towel or rag, without having to wait for it to dry before taking it out in freezing weather.

It should also be noted that if a pouch is made of plastic or similar material, construction can be less expensive, since plastic seams can be formed by heat-crimping or other means, without requiring stitching. It should also be recognized that when synthetic fabric or plastic is used, seams can often be formed by adhesive or solvent compounds, or other means.

Alternately or additionally, if desired, an inner lining can be provided, made of waterproof plastic or comparable material. This lining can be: (1) permanently affixed inside the pouch, such as by stitching; (2) removably secured inside the pouch by means such as snaps, VELCRO, etc.; or, (3) designed to simply rest inside the pouch when in use, so that it can be removed and cleaned readily and easily.

It should also be noted that an elongated rectangular pouch can be sized and designed to accommodate a resealable plastic bag, of the type commonly referred to as a “freezer baggie”, as an easily-replaceable inner lining. Compared to single-use baggies (i.e., of the type that are commonly used to carry a sandwich, and then discarded once the sandwich has been removed), “freezer baggies” are made of stronger and thicker plastic walls, and they have molded interlocking plastic seams across their openings. This type of seam provides an airtight closure, which will protect enclosed food over spans of time that may last for months, inside a freezer or refrigerator.

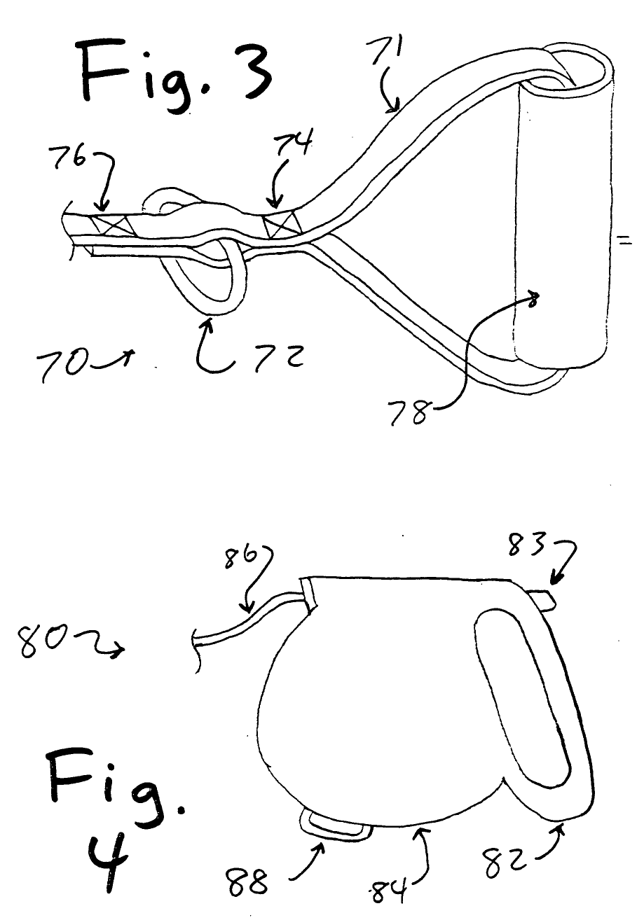

FIG. 3 depicts one end of a non-retractable dog leash 70, having a handle or other gripping component 71. Handle 71 can be created by simply bending one end of the strap into a loop, and sewing it to itself, using stitching 74 (which typically is in the form of a “boxed X”, to give it improved strength and durability). Straps generally are preferred over ropes or cords for use in mass-manufactured dog leashes, since a stronger loop can be created by sewing across the width of a strap.

Leash 70 has been modified by adding a pouch-attachment ring 72, adjacent to (or at least proximate to) the handle 71 of leash 70. Ring 72 is constrained by placing it between two sets of “box-stitching” 74 and 76. FIG. 3 also shows a molded plastic handle component 78, through which the hand-loop has been inserted. Some dog owners (especially those having large dogs) would prefer a roughly cylindrical handle segment that can be firmly, comfortably, and securely gripped by wrapping the fingers and thumb of one hand around it. This type of stiff molded handle can eliminate the uncomfortable tightening, squeezing, and pinching effect that is caused by a hand-loop made of a flexible strap, when a dog (especially a large dog) pulls and strains as hard as it can at the end of a leash. Handle component 78 can be a simple hollow cylinder, preferably with molded and rounded internal edges at both ends, to minimize scraping and fraying over years of use; alternately, it can have a finger-accommodating shape molded into one of its external sides, comparable to the molded handle 82 of retractable leash 80, shown in FIG. 5.

It should be recognized that a “dedicated” coupling device (such as ring 72) mounted on a leash is not essential, for use of a pouch as shown in FIG. 1. Instead, as shown in FIG. 1, pouch 10 can be attached to any conventional dog leash, merely by securing one strap 12 to the Y-shaped intersection where the strap segments come together at the base (or neck) of the hand-loop.

However, it is safer and preferable to provide a leash having at least a connector ring or short loop of material hanging down from the leash, at a position near the hand-loop, to avoid any risk of a sudden jerk on the leash causing a pinching action that could hurt the hand of the person holding the leash.

It should also be noted that any of various types of clip devices can be used, as will be recognzied by those skilled in the art. For example, various types of “pinch-clip” devices are known, and can be used to secure a pouch to any location along the length of a strap, rope, or cord. As one example, the type of spring-steel clips that are used to hold stacks of paper together, in an office, can be adapted for use as disclosed herein, if desired.

As another example, other classes of pinch-clip devices are used to secure a cord from a microphone or telephone headset, to a piece of clothing. These devices typically use a cylindrical sleeve that holds a spring-loaded plunger, so that depressing the plunger will open or widen an aperture on one side of the device. While the aperture remains open, the pinch-clip can be slipped over a strap or cord, from the side of the strap or cord. When the pressure on the plunger is released, the spring causes the plunger to press against the strap, thereby securing it to the strap that position. Any desired type of device can be affixed to the sleeve of this type of clip.

FIG. 4 discloses a retractable leash device 80, with handle 82, locking button 83, cord housing 84, and cord 86. A pouch coupling component 88, to which a clip on a pouch can be conveniently coupled, has been molded into the lower side of housing 84.

It should also be noted that the pouch-attachment component (such as a clip or ring) preferably should be adjacent to the hand-loop or other handle component, or at least proximate to it (in general, this indicates that the pouch-attachment component should be within a few inches of the handle), to minimize unwanted swinging or other motion of a loaded pouch.

Sized Assortments; Pouch-and-Leash Sets

This invention also discloses articles of manufacture that can be sold, in wholesale lots, to retailers or distributors.

One such article of manufacture comprises an assortment of waste-carrying pouches having three or more sizes that are suited for small, medium, and large dogs.

To provide general guidance concerning appropriate sizes, suitable ranges for pouch sizes can be roughly divided as follows, when expressed as the length of one side of a square pouch, when the pouch is laid flat: (i) about 11 by about 17 cm (about 4.5 by about 7 inches) for small dogs; (ii) about 17 by about 20 cm (about 6.5 by about 8 inches) for medium-sized dogs; (iii) about 18 by about 23 cm (about 7 by about 9 inches) for large dogs; and about 23 by about 28 cm (about 9 by about 11 inches) for extra-large dogs. These size ranges are not intended to be precise, and adjustments can be made (such as, for example, by making rectangular pouches that have comparable areas, when laid flat). Nevertheless, those size ranges are suitable, and illustrate the approach to providing different sizes for small, medium, and large dogs.

These types of assortments that can be sold wholesale can have, for example, 4 or more pouches of each size, when sold to a store that has never stocked them before and that wants to test the market, and any larger number of pouches of each size, when sold wholesale. Such assortments can also include leashes that have pouch-coupling rings or clips hanging from locations near their handles, as shown in FIGS. 3 and 4.

Another article of manufacture disclosed herein comprises matched sets that contain both a pouch and a leash. In general, the thickness, heaviness, and tensile strength of the leash should complement the size of the pouch (i.e., since different-sized leashes are sold for small, medium, and large dogs, those leashes can be matched with small, medium, and large pouches). In addition, the colors of a pouch and a leash, in a combined set, should be complementary, or identical if desired.

Thus, there has been shown and described a new and improved design for a simple, lightweight, convenient, and inexpensive waste-carrying pouch, for use by dog owners. Although this invention has been exemplified for purposes of illustration and description by referring to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A device for carrying pet feces, comprising:
(a) a pouch having a size suited for carrying pet waste, and having closure means that allow the pouch to be opened to insert pet feces contained in a plastic bag, and closed in a manner that will reliably hold the feces therein until the feces can be transferred to a suitable receptacle; and,
(b) leash-coupling means, for securely but reversibly coupling the pouch to a leash,
wherein the pouch:
(i) has at least two spaced coupling components that allow the pouch to be affixed to a leash at at least two spaced locations, in a manner that minimizes unwanted pendulous motion by a pouch that is carrying feces; and,
(ii) has walls made of a material having a stiffness that will facilitate opening and closing of the pouch despite tugging and jerking of the leash by a pet.

2. The device of claim 1, wherein the pouch is made of a nylon fabric that is impregnated or coated with a plastic material.

3. The device of claim 1, wherein the closure means is selected from the group consisting of zippers, snaps, and hook-and-loop material.

4. The device of claim 1, wherein the leash-coupling means comprises a clip device.

5. The device of claim 1, wherein the leash-coupling means comprises a ring to which a clip can be secured.

6. The device of claim 1, wherein the leash-coupling means is coupled to the pouch by means of two straps that are positioned proximate to spaced corners of the pouch.

7. An article of manufacture, comprising a pet leash having a handle, and a pouch for carrying pet waste, wherein:
(a) the pouch has a size suited for carrying pet waste, and has closure means that allow the pouch to be opened to insert pet feces contained in a plastic bag, and closed in a manner that will reliably hold the feces therein until the feces can be transferred to a suitable receptacle; and,
(b) at least one of said leash and pouch has coupling means for securely but reversibly coupling the pouch to the leash,
and wherein the pouch and leash have at least two spaced coupling components that allow the pouch to be affixed to the leash at at least two spaced locations in a manner that minimizes unwanted pendulous motion by a pouch carrying feces;
and wherein the pouch has walls made of a material having a stiffness that will facilitate opening and closing of the pouch despite tugging and jerking of the leash by a pet.

8. The article of manufacture of claim 7, wherein the pouch is made of a nylon fabric that is impregnated or coated with a plastic material.

9. The article of manufacture of claim 7, wherein the closure means is selected from the group consisting of zippers, snaps, and hook-and-loop material.

10. The article of manufacture of claim 7, wherein the coupling means comprises a clip device.

11. The article of manufacture of claim 7, wherein the coupling means comprises a ring to which a clip can be secured.

12. The article of manufacture of claim 7, wherein the coupling means comprises two straps that are mounted on the pouch, at positions proximate to spaced corners of the pouch.

13. An article of manufacture, comprising:
a. a pet leash, having a handle, and having a pouch-coupling device securely attached to the pet leash at a location proximate to the handle; and,
b. a pouch, having a size suited for carrying pet waste, and having closure means that allow the pouch to be opened to insert pet feces contained in a plastic bag, and closed in a manner that will reliably hold the feces therein until the feces can be transferred to a suitable receptacle; and having at least two spaced leash-coupling means, for securely but reversibly coupling the pouch to a leash.

14. The article of manufacture of claim 13, wherein the pouch-coupling device and the leash-coupling means are each selected from the group consisting of a clip device, and a ring to which a clip can be secured.

15. The article of manufacture of claim 13, wherein the pouch is made of a material selected from the group consisting of clear plastic, opaque plastic, and synthetic fabric coated or impregnated with plastic.

16. An article of manufacture, comprising an assortment of pouches suited for carrying pet waste, each pouch having closure means that allow the pouch to be opened to insert pet feces contained in a plastic bag, and closed in a manner that will reliably hold the feces therein until the feces can be transferred to a suitable receptacle, and each pouch also having at least two leash-coupling means for securely but reversibly coupling the pouch to a leash, wherein the assortment of pouches comprises:
a. a plurality of pouches having sizes that are appropriate for carrying fecal matter from small dogs;
b. a plurality of pouches having sizes that are appropriate for carrying fecal matter from medium-sized dogs; and,
c. a plurality of pouches having sizes that are appropriate for carrying fecal matter from large dogs,
and wherein the pouches have walls made of a material having a stiffness that will facilitate opening and closing of the pouch despite tugging and jerking of the leash by a pet.

17. The article of manufacture of claim 16, which also comprises a plurality of pet leashes.

18. The article of manufacture of claim 16, wherein the plurality of pet leashes comprises:
a. a plurality of leashes having sizes appropriate for small dogs;
b. a plurality of leashes having sizes appropriate for medium-sized dogs; and,
c. a plurality of leashes having sizes appropriate for large dogs.
